(19) United States
(12) Patent Application Publication
(10) Pub. No.: US 2018/0119814 A1
(43) Pub. Date: May 3, 2018

(54) CONTROL METHOD FOR SYNCHRONOUS SHIFTING OF A TRANSMISSION COMPRISING A COTINUOUSLY VARIABLE PLANETARY MECHANISM

(71) Applicant: DANA LIMITED, MAUMEE, OH (US)

(72) Inventors: JEFFREY M. DAVID, CEDAR PARK, TX (US); GORDON MCINDOE, VOLENTE, TX (US); T. NEIL MCLEMORE, GEORGETOWN, TX (US)

(73) Assignee: DANA LIMITED, MAUMEE, OH (US)

(21) Appl. No.: 15/572,288

(22) PCT Filed: May 5, 2016
(86) PCT No.: PCT/US16/30930

§ 371 Date: Nov. 7, 2017

Related U.S. Application Data
(60) Provisional application No. 62/158,847, filed on May 8, 2015.

(51) Int. Cl. F16H 61/70; F16H 61/664; F16H 37/02; F16H 61/04; F16H 15/50

(52) U.S. Cl. CPC F16H 61/702; F16H 61/6646; F16H 2037/025; F16H 61/0403; F16H 15/503; F16H 37/021

(57) ABSTRACT

A control system for a multiple-mode continuously variable transmission is described as having a ball planetary variator operably coupled to multiple-mode gearing. The control system has a transmission control module configured to receive a plurality of electronic input signals, and to determine a mode of operation from a plurality of control ranges based at least in part on the plurality of electronic input signals. In some embodiments, the system also has a ratio schedule module configured to store at least one shift schedule map, and configured to determine a desired speed ratio of the variator based at least in part on the mode of operation; a variator control module configured to receive the desired speed ratio and configured to determine an actuator setpoint signal based at least in part on the mode of operation; and a torque reversal module.

### CROSS-REFERENCE

The present application claims the benefit of U.S. Provisional Application No. 62/158,847, filed May 8, 2015 which is incorporated herein by reference in its entirety.

### BACKGROUND OF THE INVENTION

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that may be implemented in a CVT may not be sufficient for some applications. A transmission may implement a combination of a CVT with one or more additional CVT stages, one or more fixed ratio range splitters, or some combination thereof in order to extend the range of available ratios. The combination of a CVT with one or more additional stages further complicates the ratio control process, as the transmission may have multiple configurations that achieve the same final drive ratio.

The different transmission configurations can, for example, multiply input torque across the different transmission stages in different manners to achieve the same final drive ratio. However, some configurations provide more flexibility or better efficiency than other configurations providing the same final drive ratio.

The criteria for optimizing transmission control may be different for different applications of the same transmission. For example, the criteria for optimizing control of a transmission for fuel efficiency may differ based on the type of prime mover applying input torque to the transmission. Furthermore, for a given transmission and prime mover pair, the criteria for optimizing control of the transmission may differ depending on whether fuel efficiency or performance is being optimized.

### SUMMARY OF THE INVENTION

Provided herein is a control system for a multiple-mode continuously variable transmission having a ball planetary variator operably coupled to multiple-mode gearing, the control system comprising: a transmission control module configured to receive a plurality of electronic input signals, and configured to determine a mode of operation from a plurality of control ranges based at least in part on the plurality of electronic input signals; a ratio schedule module configured to store at least one shift schedule map, and configured to determine a desired speed ratio of the variator based at least in part on the mode of operation; a variator control module configured to receive the desired speed ratio, and configured to determine an actuator setpoint signal based at least in part on the mode of operation and a torque reversal module configured to receive a mode of operation, and determine a signal indicative of a torque reversal event based at least in part on the desired speed ratio and the actuator setpoint signal. In some embodiments, the control system further comprises a mode control module configured to receive a plurality of electronic input signals, and configured to determine a plurality of clutch control signals. In some embodiments of the control system, the ratio schedule module is configured to receive a user input indicative of a desired sport mode. In some embodiments of the control system, the ratio schedule module is configured to receive a user input indicative of a desired economy mode. In some embodiments of the control system, the ratio schedule module is configured to store a shift schedule map for operation in a sport mode. In some embodiments of the control system, the ratio schedule module is configured to store a shift schedule map for operation in an economy mode. In some embodiments of the control system, the ratio schedule module has a lock ratio module configured to hold the desired speed ratio at a constant value during a deceleration event. In still other embodiments of the control system, the variator control module further comprises a position control module and a ratio control module. In some embodiments of the variator control module, the position control module is configured to determine an actuator position setpoint based at least in part on vehicle speed.

Provided herein is a control system for a multiple mode continuously variable transmission having a ball planetary variator operably coupled to multiple-mode gearing, the control system comprising: a transmission control module comprising at least one processor configured to perform executable instructions, a memory, and instructions executable by the processor to configure the transmission control module to receive a plurality of electronic input signals and determine a mode of operation from a plurality of control ranges based at least in part on the plurality of electronic input signals, the transmission control module comprising: a ratio schedule module configured to perform executable instructions from the memory, and perform instructions executable by the processor to configure the ratio schedule module to store at least one shift schedule map and determine a desired speed ratio of the variator based at least in part on the mode of operation; a variator control module configured to perform executable instructions from the memory, and perform instructions executable by the processor to configure the variator control module to receive the desired speed ratio and determine an actuator setpoint signal based at least in part on the mode of operation; and a torque reversal module configured to perform executable instructions from the memory, and perform instructions executable by the processor to configure the torque reversal module to receive a mode operation and determine a signal indicative of a torque reversal event based at least in part on the desired speed ratio and the actuator setpoint signal. In some embodiments of the control system, the transmission control module further comprises: a ratio schedule module configured to perform executable instructions from the memory, and perform instructions executable by the processor to configure the ratio schedule module to receive signals such as a throttle position, a vehicle speed, and a user-selectable mode; a clutch control module configured to perform executable instructions from the memory, and perform instructions executable by the processor to configure the clutch control module to receive and send electronic signals to solenoids within a multiple-mode gearing portion of the transmission; and a variator control module configured to perform executable instructions from the memory, and perform instructions executable by the processor to configure the variator control module to receive input signals comprising; current variator speed ratio; current variator actuator position; throttle position; engine torque; and desired operating mode; wherein the variator control module is configured to determine an actuator setpoint signal based at least in part on the mode of operation and a torque reversal module configured to receive a mode operation, and determine a signal indicative of a torque reversal event based at least in part on the desired speed ratio and the actuator setpoint signal. In some embodiments of the transmission control module, the variator control module comprises: the torque reversal module configured to perform executable instructions from the memory, and perform instructions executable by the processor to configure the torque reversal module to determine the presence of a torque reversal event due to a shift in mode; a normal speed ratio command module configured to perform executable instructions from the memory, and perform instructions executable by the processor to configure the normal speed ratio command module to determine a speed ratio setpoint; and a torque reversal speed ratio command module configured to perform executable instructions from the memory, and perform instructions executable by the processor to configure the torque reversal speed ratio command module to determine a speed ratio setpoint during a torque reversal. Still further, some embodiments of the control system further comprise, a module governing aspects of control, monitoring, and communication within the control system configured to perform executable instructions from the memory, and perform instructions executable by the processor. In some embodiments of the control system, the variator control module further comprises: a position control module to control the variator based on actuator position alone at low or near zero speed conditions, during the synchronous mode shift, or under other predetermined conditions.

Provided herein is a method of operating a continuously variable transmission having a variator operably coupled to a multiple-mode gearing having a first clutch and a second clutch, the method comprising: operating a continuously variable planetary having a plurality of tiltable balls in contact with a first traction ring assembly and a second traction ring assembly, wherein a speed ratio between the first traction ring assembly and the second traction ring assembly corresponds to a tilt angle of the balls; operating a digital processing device comprising an operating system configured to perform executable instructions and a memory device; operably coupling the continuously variable planetary to the first clutch and the second clutch; comparing a current speed ratio of the transmission to an upshift speed ratio set point stored in the memory device; comparing a current vehicle speed to an upshift vehicle speed set point stored in the memory device; and commanding an upshift of the multiple mode gearing based at least in part on the comparisons. In some embodiments, the method includes comparing the current speed ratio of the transmission to a downshift speed ratio set point stored in the memory device. In some embodiments, the method includes comparing the current vehicle speed to a downshift vehicle set point. In some embodiments, the method includes commanding a downshift of the multiple mode gearing based at least in part on the comparisons. In some embodiments of the method, commanding a downshift of the multiple-mode gearing further comprises engaging the first clutch and disengaging the second clutch. In some embodiments of the method, commanding an upshift of the multiple-mode gearing further comprises disengaging the first clutch and engaging the second clutch.

Provided herein is a computer-implemented system for a vehicle having an engine coupled to a continuously variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage a plurality of vehicle driving conditions; a plurality of sensors configured to monitor vehicle parameters comprising: Variator Speed Ratio, Engine Speed, Variator position, Vehicle Speed, wherein the software module is configured to execute a transmission control module, wherein the transmission control module includes a plurality of calibration variables configured to store values of an upshift speed ratio, a downshift speed ratio, an upshift vehicle speed, and a downshift vehicle speed. In some embodiments of the computer-implemented system, the transmission control module further comprises mode control module configured to determine a model of operation and a plurality of clutch command signals based at least in part the variator speed ratio, the vehicle speed, the upshift speed ratio, the downshift speed ratio, the upshift vehicle speed, and the downshift vehicle speed. In some embodiments of the computer-implemented system, the transmission control module further comprises a variator control module configured to determine a variator speed ratio setpoint and determine an actuator setpoint signal based at least in part on the mode of operation. In some embodiments of the computer-implemented system, the transmission control module further comprises an engine torque control module configured to determine an engine torque setpoint based at least in part on a plurality of torque limit signals. In some embodiments of the computer-implemented system, the plurality of torque limit signals include a torque reversal torque limit signal. In some embodiments of the computer-implemented system, the plurality of torque limit signals include a shift torque limit signal. In some embodiments of the computer-implemented system, the plurality of torque limit signals include a braking torque limit signal. In some embodiments of the computer-implemented system, the plurality of torque limit signals include a traction contact torque limit signal. In some embodiments of the computer-implemented system, the variator control module includes a ratio map module and a ratio calculation module. In some embodiments of the computer-implemented system, the variator control module further comprises a lock ratio module configured to implement a temporary hold on a transmission speed ratio based at least in part on the mode of operation. In some embodiments of the computer-implemented system, the ratio map module includes a plurality of calibration maps configured to store values of variator speed ratio setpoints based at least in part on an engine throttle position signal and a vehicle speed. In some embodiments of the computer-implemented system, the ratio calculation module is configured to calculate a CVT speed ratio setpoint signal based at least in part on a target engine speed signal and a transmission output speed signal.

Provided herein is a method of operating a continuously variable transmission having a variator operably coupled to a multiple-mode gearing having a first clutch and a second clutch, the method comprising: operating a continuously variable planetary having a plurality of tiltable balls in contact with a first traction ring assembly and a second traction ring assembly, wherein a speed ratio between the first traction ring assembly and the second traction ring assembly corresponds to a tilt angle of the balls; operating a digital processing device comprising an operating system configured to perform executable instructions and a memory device; operably coupling the continuously variable planetary to the first clutch and the second clutch; operably coupling an actuator to the continuously variable planetary, the actuator configured to adjust the tilt angle of the balls, and the actuator configured to apply a holding force on the continuously variable planetary; comparing a current speed ratio of the transmission to an upshift speed ratio threshold stored in the memory device; commanding a reduction in the holding force; and commanding an upshift of the multiple mode gearing based at least in part on the comparison to the upshift speed ratio threshold stored in the memory device. In some embodiments, the method includes the step of comparing the current speed ratio of the transmission to a synchronous speed ratio setpoint stored in the memory device. In some embodiments, the method includes the step of commanding the disengagement of the first clutch based at least in part on the comparison of the current speed ratio of the transmission to the synchronous speed ratio setpoint stored in the memory device. In some embodiments, the method includes the step of commanding an increase in the holding force based at least in part on commanding the disengagement of the first clutch. In some embodiments, the method includes the step of comparing the current speed ratio of the transmission to a downshift speed ratio threshold stored in the memory device. In some embodiments, the method includes the step of commanding a reduction of the holding force based at least in part on the comparison to the downshift speed ratio threshold stored in the memory device. In some embodiments, the method includes the step of commanding an engagement of the first clutch based at least in part on the comparison to the downshift speed ratio threshold stored in the memory device. In some embodiments, the method includes the step of comparing the current vehicle speed to an upshift vehicle speed threshold stored in the memory device. In some embodiments, the method includes the step of comparing the current vehicle speed to a downshift vehicle speed threshold stored in the memory device.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a schematic diagram of a representative multiple-mode transmission having a continuously variable planetary and a range box.

FIG. 2 is a chart depicting variator speed ratio versus transmission speed ratio under ideal operating conditions of the transmission of FIG. 1.

FIG. 3 is a chart depicting variator speed ratio versus transmission speed ratio under actual operating conditions of the transmission of FIG. 1.

FIG. 4 is a chart depicting variator speed ratio versus transmission speed ratio for actual operating conditions when a transmission control system is implemented for operation of the transmission of FIG. 1.

FIG. 5 is a chart depicting relationships between transmission input speed, transmission output torque, variator speed ratio, and transmission speed ratio during a shift from operating mode 1 to operating mode 2 of the transmission of FIG. 1.

FIG. 6 is a block diagram depicting a control system for the transmission of FIG. 1.

FIG. 7 is a block diagram depicting a transmission control module of the control system of FIG. 6.

FIG. 8 is a block diagram depicting a ratio schedule module of the transmission control module of FIG. 7.

FIGS. 9 is a block diagram depicting a variator control module of the transmission control module of FIG. 7.

FIG. 10 is a block diagram depicting torque reversal module having an algorithm to determine a torque reversal event during operation of the transmission of FIG. 1.

FIG. 11 is a block diagram depicting a speed ratio command module during normal operation used in the variator control module of FIG. 9.

FIG. 12 is a block diagram depicting a speed ratio command module during a torque reversal event used in the variator control module of FIG. 9.

FIG. 13 is a block diagram depicting another transmission control module of the control module of FIG. 6.

FIG. 14 is a block diagram depicting a variator control module of FIG. 13.

FIG. 15 is a block diagram depicting a ratio map module of FIG. 14.

FIG. 16 is a block diagram depicting a ratio calculation module of FIG. 14.

FIG. 17 is a block diagram depicting an engine torque control module of FIG. 13.

FIG. 18 is a flow chart depicting a control process that is implemented in the transmission control module of FIG. 6 or FIG. 13.

FIG. 19 is a flow chart depicting a control process that is implemented in the transmission control module of FIG. 6 or FIG. 13.

FIG. 20 is a side sectional view of a ball-type variator.

FIG. 21 is a plan view of a carrier member that is used in the variator of FIG. 19.

FIG. 22 is an illustrative view of different tilt positions of the ball-type variator of FIG. 20.

### DETAILED DESCRIPTION OF THE INVENTION

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, vehicle speed, gear selector position, user-selectable mode configurations, and the like, or some combination thereof. The gear selector position is typically a PRNDL position. The electronic controller can also receive one or more control inputs. The electronic controller can determine an active mode and a variator ratio based on the input signals and control inputs. The electronic controller can control an overall transmission ratio of the variable ratio transmission by controlling one or more electronic actuators and/or hydraulic actuators such as solenoids that control the ratios of one or more portions of the variable ratio transmission.

The electronic controller described herein is described in the context of a continuous variable transmission, such as the continuous variable transmission of the type described in Patent Application Number PCT/US2014/41124, entitled “3-Mode Front Wheel Drive And Rear Wheel Drive Continuously Variable Planetary Transmission,” assigned to the assignee of the present application and hereby incorporated by reference herein in its entirety. However, the electronic controller is not limited to controlling a particular type of transmission but can be configured to control any of several types of variable ratio transmissions.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1234A and bearing 1234B) will be referred to collectively by a single label (for example, bearing 1234).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

For description purposes, the terms “prime mover”, “engine,” and like terms, are used herein to indicate a power source. Said power source is optionally fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology. For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that brake position and throttle position sensors are optionally electronic, and in some cases, well-known potentiometer type sensors. These sensors are capable of providing a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0-100%, where 0% is indicative of the lowest signal value, for example a pedal that is not compressed, and 100% is indicative of the highest signal value, for example a pedal that is fully compressed. There are optional implementations of the control system where the brake pedal is effectively fully engaged with a sensor reading of 20%-100%. Likewise, a fully engaged throttle pedal optionally corresponds to a throttle position sensor reading of 20%-100%. The sensors, and associated hardware for transmitting and calibrating the signals, are capable of being selected in such a way as to provide a relationship between the pedal position and signal to suit a variety of implementations. Numerical values given herein are included as examples of one implementation and not intended to imply limitation to only those values. For example, a minimum detectable threshold for a brake pedal position is optionally 6% for a particular pedal hardware, sensor hardware, and electronic processor. Whereas an effective brake pedal engagement threshold is optionally 14%, and a maximum brake pedal engagement threshold optionally begins at or about 20% compression. As a further example, a minimum detectable threshold for an accelerator pedal position is optionally 5% for a particular pedal hardware, sensor hardware, and electronic processor. Similar or completely different pedal compression threshold values for effective pedal engagement and maximum pedal engagement optionally also apply for the accelerator pedal.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20. degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.05 degrees of a given value or range.

In certain embodiments, the term “about” or “approximately” means within 5.0 mA, 1.0 mA, 0.9 mA, 0.8 mA, 0.7 mA, 0.6 mA, 0.5 mA, 0.4 mA, 0.3 mA, 0.2 mA, 0.1 mA, 0.09 mA, 0.08 mA, 0.07 mA, 0.06 mA, 0.05 mA, 0.04 mA, 0.03 mA, 0.02 mA or 0.01 mA of a given value or range.

As used herein, “about” when used in reference to a velocity of the moving object or movable substrate means variation of 1%-5%, of 5%-10%, of 10%-20%, and/or of 10%-50% (as a percent of the percentage of the velocity, or as a variation of the percentage of the velocity). For example, if the percentage of the velocity is “about 20%”, the percentage optionally varies 5%-10% as a percent of the percentage i.e. from 19% to 21% or from 18% to 22%; alternatively the percentage optionally varies 5%-10% as an absolute variation of the percentage i.e. from 15% to 25% or from 10% to 30%.

In certain embodiments, the term “about” or “approximately” means within 0.01 sec., 0.02 sec, 0.03 sec., 0.04 sec., 0.05 sec., 0.06 sec., 0.07 sec., 0.08 sec. 0.09 sec. or 0.10 sec of a given value or range. In certain embodiments, the term “about” or “approximately” means within 0.5 rpm/sec, 1.0 rpm/sec, 5.0 rpm/sec, 10.0 rpm/sec, 15.0 rpm/sec, 20.0 rpm/sec, 30 rpm/sec, 40 rpm/sec, or 50 rpm/sec of a given value or range.

Those of skill will recognize that the various illustrative logical blocks, modules, circuits, strategies, schemes, and algorithm steps described in connection with the embodiments disclosed herein, including with reference to the transmission control system described herein, for example, is optionally implemented as electronic hardware, software stored on a computer readable medium and executable by a processor, or combinations of both. To clearly illustrate this interchangeability of hardware and software, various illustrative components, blocks, modules, circuits, strategies, schemes, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present invention. For example, various illustrative logical blocks, modules, strategies, schemes, and circuits described in connection with the embodiments disclosed herein is optionally implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor is optionally a microprocessor, but in the alternative, the processor is optionally any conventional processor, controller, microcontroller, or state machine. A processor is also optionally implemented as a combination of computing devices, e.g., a combination of a DSP and a microprocessor, a plurality of microprocessors, one or more microprocessors in conjunction with a DSP core, or any other such configuration. Software associated with such modules optionally resides in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor is capable of reading information from, and writing information to, the storage medium. In the alternative, the storage medium is optionally integral to the processor. The processor and the storage medium optionally reside in an ASIC. For example, in one embodiment, a controller for use of control of the IVT comprises a processor (not shown).

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the control system for a vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments the control system for a vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the control system for a vehicle equipped with an infinitely variable transmission disclosed herein includes at least one computer program, or use of the same. A computer program includes a sequence of instructions, executable in the digital processing device's CPU, written to perform a specified task. Computer readable instructions are optionally implemented as program modules, such as functions, objects, Application Programming Interfaces (APIs), data structures, and the like, that perform particular tasks or implement particular abstract data types. In light of the disclosure provided herein, those of skill in the art will recognize that a computer program is optionally written in various versions of various languages.

The functionality of the computer readable instructions are optionally combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

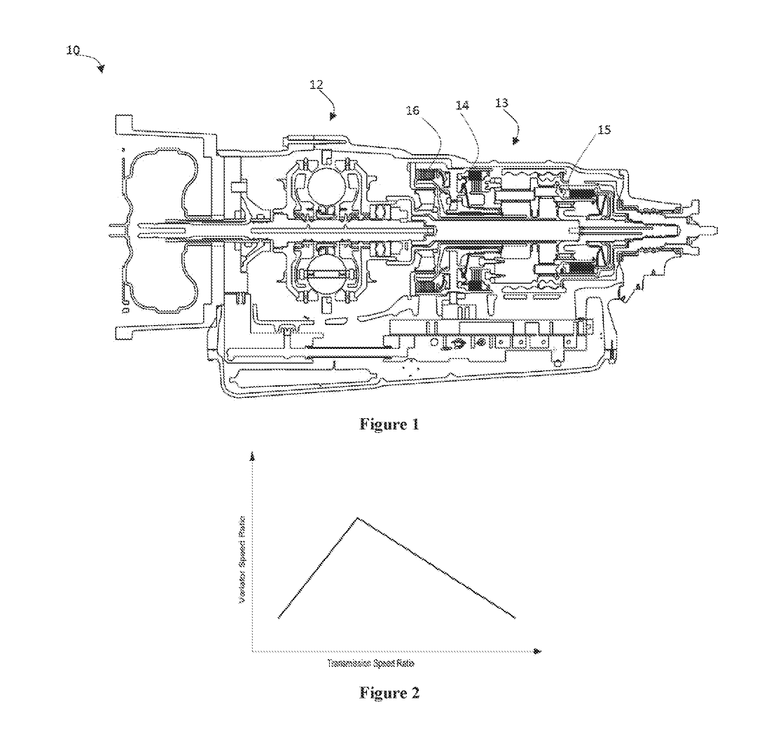

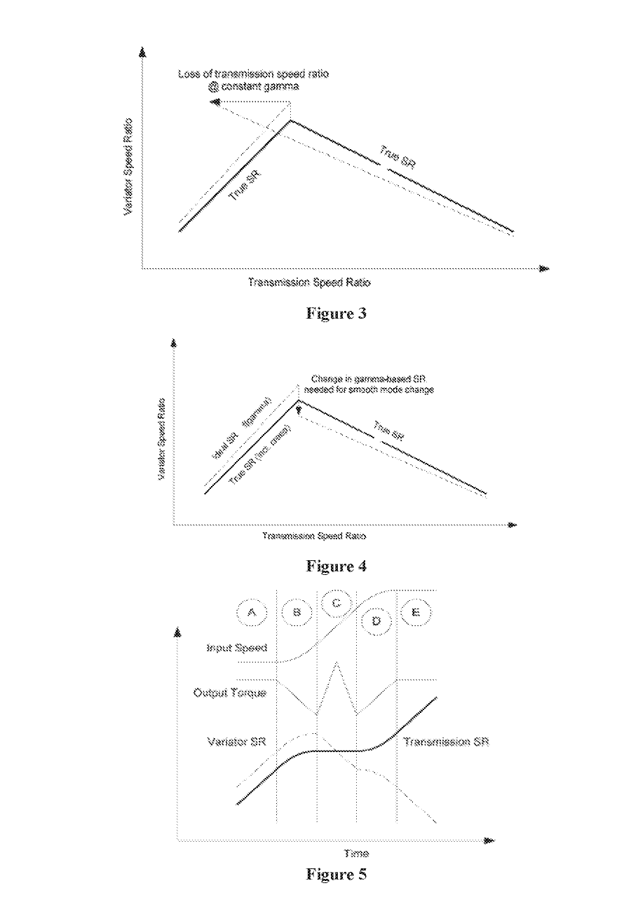

Referring now to FIG. 1, a transmission 10 is an illustrative example of a transmission having a continuously variable ratio portion, or variator 12 (sometimes referred to herein as “CVP”), and a multiple-mode gearing portion 13. During operation of the transmission 10, the ideal relationship between the variator speed ratio and the transmission speed ratio is depicted in the chart of FIG. 2. Under a first mode of operation, the relationship between the variator speed ratio and transmission speed ratio is depicted by a line having a positive slope. For example, the first mode of operation corresponds to the engagement of a first clutch 14. Under a second mode of operation, the relationship between the variator speed ratio and transmission speed ratio is depicted by a line having a negative slope. The second mode of operation corresponds to the disengagement of the first clutch 14 and an engagement of a second clutch 15. In some embodiments, the transmission shifts from the first mode to the second mode when the speed of the off-going (or disengaging) clutch is nearly equal to the speed of the on-going (or engaging) clutch. This type of shift event, depicted on the graph as the point of change in positive to negative slope, is referred to as the synchronous shift point. Torque transmitted through the variator portion during the transition between the first and second modes reverses direction and consequently produces a change in the actual variator speed ratio. In some embodiments, a reverse clutch 16 is included in the multiple-mode gearing portion 13. The reverse clutch 16 is configured to provide a reverse mode of operation. As illustrated in FIG. 3, in the absence of adjustment of the variator (CVP) portion, there is a significant loss of transmission speed ratio and an instantaneous drop in output torque during the transition at the synchronous point due to creep at the traction contacts of the variator portion. FIG. 4 illustrates the variator speed ratio versus transmission speed ratio in the presence of an active adjustment or compensation to the variator portion during the synchronous shift event. To elucidate, FIG. 5 depicts the relationship between input speed, output torque, variator speed ratio and transmission speed ratio during a synchronous shift event. During phase “C”, the first clutch 14 and the second clutch 15 are engaged, forcing a constant transmission speed ratio regardless of variator position. During this time, the variator speed ratio is changed from a value appropriate for the loads (and associated creep) of the first operating mode to a new value appropriate for a second operating mode. During the ramps into and out of this phase (phases “B” and “D”), the ratio rate of change is temporarily and smoothly reduced to zero to avoid sharp torque transitions. The excess input speed accumulated during the event can subsequently be reduced by longer-term ratio control.

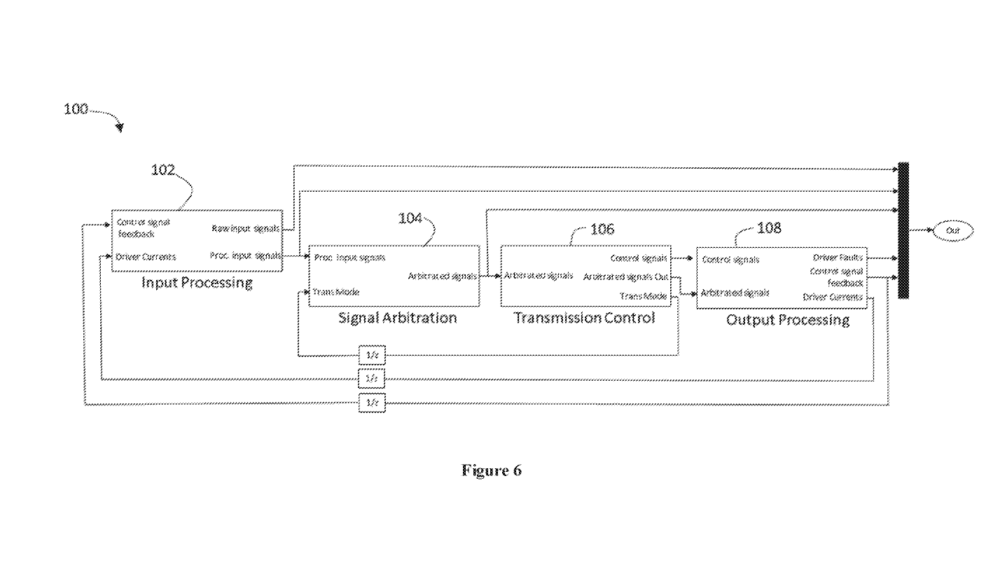

Turning now to FIG. 6, in some embodiments a control system 100 can have an input processing module 102 in communication with a signal arbitration module 104, a transmission control module 106, and an output signal processing module 108. The input processing module 102 is configured to read a number of sensors from the transmission 10, engine, and/or vehicle (not shown). For example, the input processing module 102 can read signals from temperature sensors, pressure sensors, speed sensors, digital sensors such as range indicators or pressure switches, and Controller Area Network (CAN) signals. The signal arbitration module 104 is configured to select the appropriate signal to pass to the transmission control module 106 for a number of variables. For example, a variable indicative of input speed to the transmission may be selected from a sensor directly measuring the input speed or the input speed to the transmission can be calculated from other measured signals. The signal arbitration module 104 is configured to select from primary, secondary, etc. sources for each variable needed for processing in the transmission control module 106. The output processing module 108 is configured to convert the values for commanded variables generated in the transmission control module 106 into voltage signals that are sent to corresponding actuators and/or solenoids in the transmission 10. In some embodiments, the voltage signals are typical pulse-width-modulation signals (PWM).

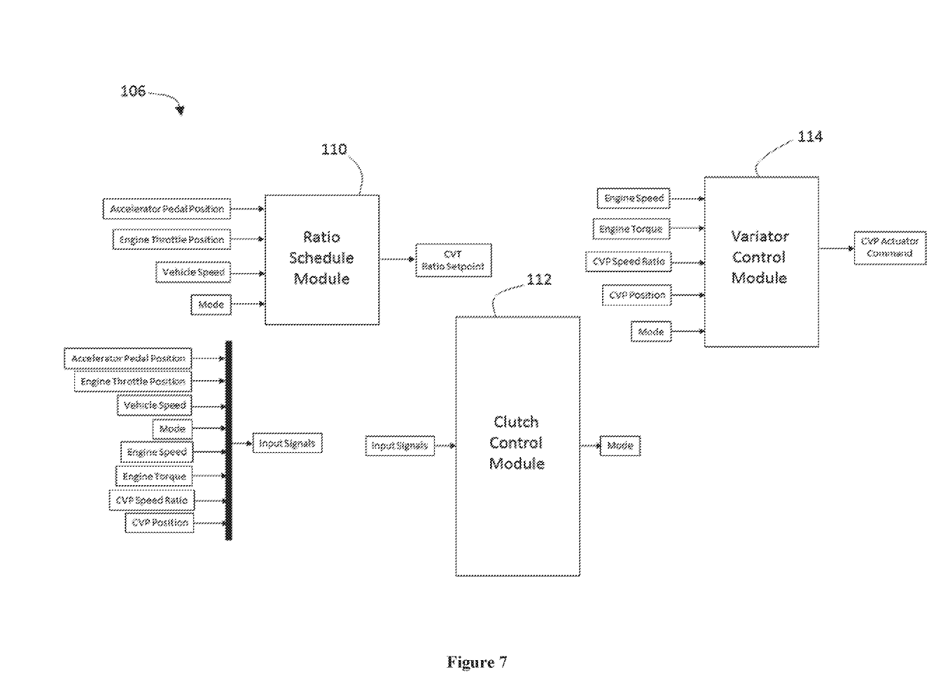

Referring now to FIG. 7, in some embodiments a transmission control module 106 can include a ratio schedule module 110, a clutch control module 112, and a variator control module 114, among other modules governing aspects of control, monitoring, and communication within the control system 100. In some embodiments, the clutch control module 112 is configured to receive and send electronic signals to solenoids within the multiple-mode gearing portion 13 of the transmission 10. It should be noted that methods and systems related to hydraulic solenoid control of clutches in transmissions are well known and can be applied appropriately in the clutch control module 112.

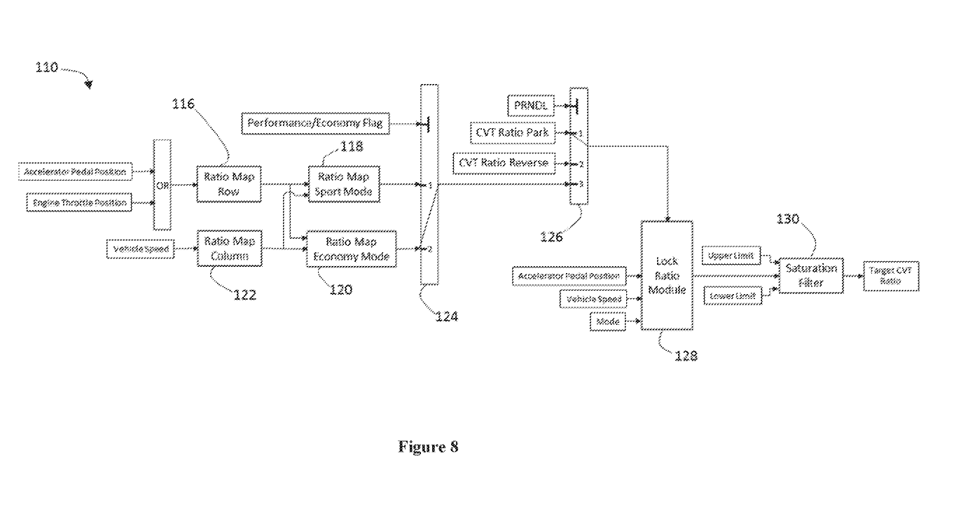

Referring to FIG. 8, in some embodiments the ratio schedule module 110 is configured to receive signals such as a throttle position, a vehicle speed, and a user-selectable mode. In some embodiments, the user-selectable mode is received from a button or knob located in the interior of a vehicle. The signal from the user-selectable mode can be indicative of a “sport mode” or in some cases an “economy mode”. The ratio schedule module 110 can be configured to receive an input signal indicative of the transmission operating mode corresponding to clutch engagement. The throttle position signal can be compared in block 116 to determine a row number to be passed to block 118 and/or block 120. Likewise, the vehicle speed signal can be compared in block 122 to determine a column number to be passed to block 118 and/or block 120. In some embodiments, the block 118 and/or the block 120 are calibration tables storing values of speed ratio as a function of throttle position and vehicle speed. As used here, the terms “table”, “look-up table”, or “map” refer to an array of indexed values stored in memory containing output values associated with each input value. The block 118 can be calibrated for a desired “sport mode”, and the block 120 can be calibrated for a desired “economy mode”, for example. The resulting speed ratio signal is passed from the blocks 118, 120 to a selector module 124 where the user-selectable mode is applied. The selected speed ratio signal is passed to a selector module 126 where a gear indicator (for example, PRNDL position) is evaluated. For PRNDL position indicating a “park” condition, a predetermined speed ratio value for park is passed to the next step. For PRNDL position indicating a “reverse” condition, a predetermined speed ratio value for reverse is passed to the next step. For PRNDL positions requiring forward drive operation, the selected speed ratio signal is passed to the next step. In some embodiments, the selected speed ratio signal is passed to a lock ratio module 128. The lock ratio module 128 receives signals indicative of vehicle speed, transmission mode, and an accelerator pedal position to determine the desired speed ratio for a vehicle deceleration condition. In some cases, the lock ratio module 128 is calibrated to prevent the condition known as “engine braking”. The selected speed ratio setpoint signal can be limited at a block 130 within a predetermined range indicative of the hardware of transmission 10 and passed as a speed ratio setpoint signal.

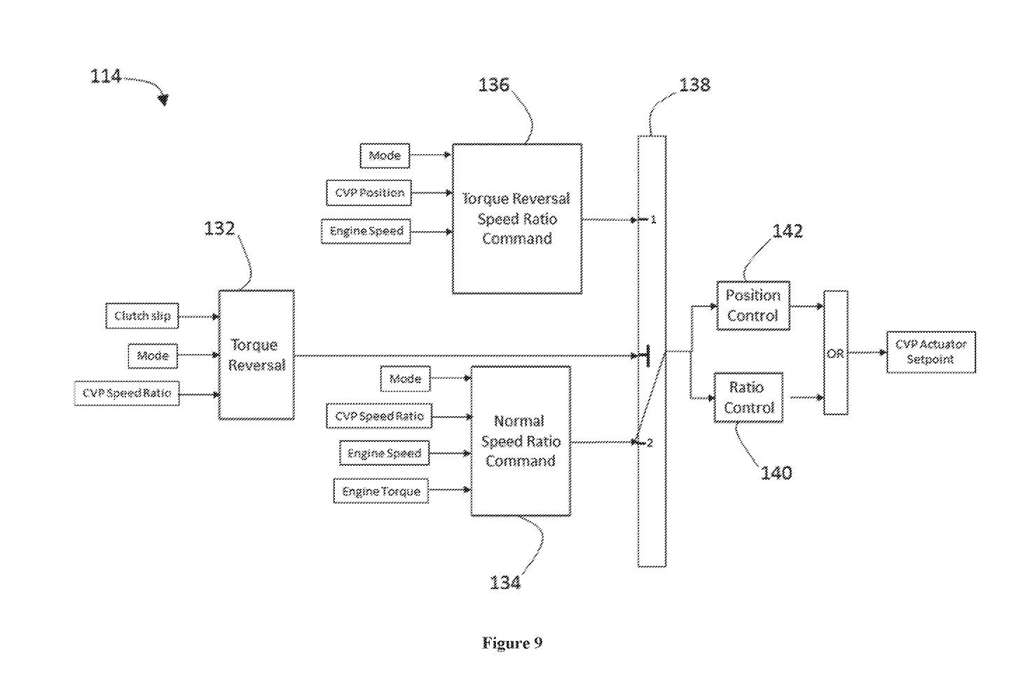

Moving now to FIG. 9, in some embodiments, the variator control module 114 includes a torque reversal module 132, a normal speed ratio command module 134 and, a torque reversal speed ratio command module 136, among others. The speed ratio setpoint signal determined, for example, in the ratio schedule module 110, is received as an input signal to the variator control module 114. The variator control module 114 receives input signals such as current variator speed ratio, current variator actuator position, throttle position, engine torque, and/or desired operating mode, among others. In some embodiments, the signal for desired operating mode is indicative of a change from mode 1 to mode 2, or vice versa. The torque reversal module 132 determines the presence of a mode shift event, or stated differently, the presence of a torque reversal event through the variator 12 due to a shift in mode. The torque reversal module 132 passes an output variable indicative of a torque reversal event, that is a digital 1 or 0, to a selector block 138. At the selector block 138, the speed ratio setpoint is selected based on the results of the torque reversal module 132. For a false result, or no torque reversal event, the speed ratio setpoint from the normal speed ratio command module 134 is passed out of the selector block 138. For a true result, when there is a torque reversal event caused by a shift from mode 1 to mode 2, or vice versa, for example, the speed ratio setpoint from the torque reversal speed ratio command module 136 is passed out of the selector block 138. The speed ratio setpoint is passed to a ratio control module 140 where the actuator setpoint for the variator 12 is determined based at least in part on the speed ratio setpoint. In some operating conditions, for example very low vehicle speeds, it is appropriate to control the variator 12 based on actuator position alone. A position control module 142 is provided in the variator control module 114 to govern low or near zero speed conditions or during mode shifts.

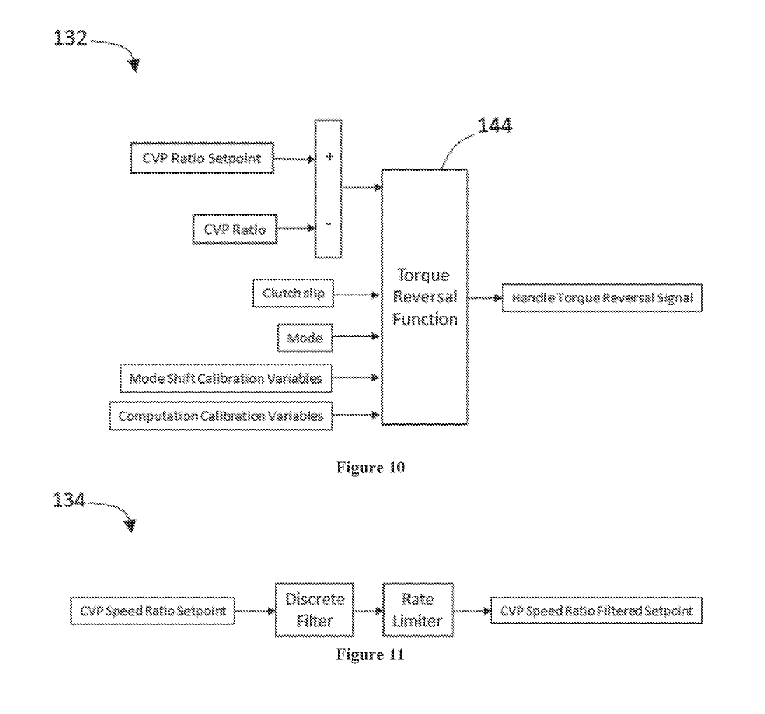

Referring now to FIG. 10, in some embodiments torque reversal module 132 receives input signals indicative of the speed ratio setpoint and the current variator speed ratio. The two input signals are compared to determine an error value. The error or difference between the speed ratio setpoint signal and the current (or actual) variator speed ratio is passed to a function module 144. The function module 144 receives signals from the clutch control module 112. The function module 144 can be a script or other algorithm that compares the input signals to predetermined values and determines if a shift from mode 1 to mode 2 or vice versa is occurring. The function module 144 produces a false result, or a 0 value, when the transmission is in a constant mode. The function module 144 produces a true result, or a 1 value, when the transmission clutches are engaging and disengaging corresponding to a shift from mode 1 to mode 2, or vice versa.

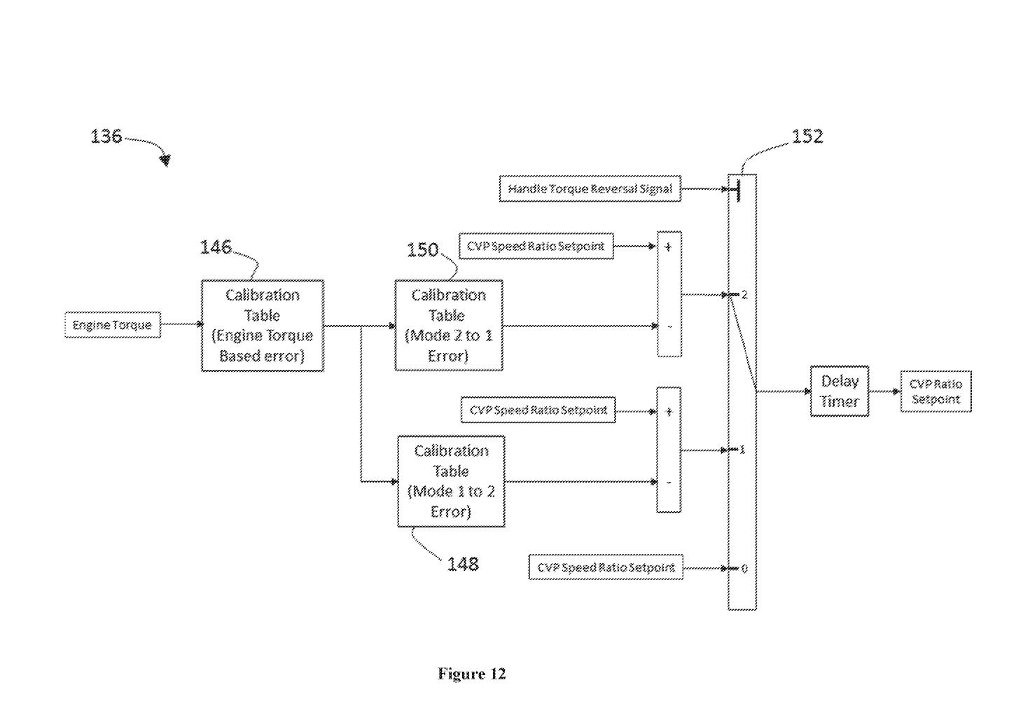

Referring now to FIGS. 11 and 12, in some embodiments the normal speed ratio command module 134 receives the speed ratio setpoint and applies a discrete filter and rate limits before passing the result on as an output to the variator control module 114. In some embodiments, the torque reversal speed ratio command module 136 receives input signals indicative of the speed ratio setpoint, the engine torque (or the input torque to the variator 12), and the result of the torque reversal module 132. The engine torque signal, or the signal indicative of the input torque to the variator 12, is passed to a calibration table 146 where a corresponding error in speed ratio setpoint and actual speed ratio is stored. It should be noted that the error in speed ratio and actual speed ratio is dependent on the operating torque of the transmission 10. The error is sometimes referred to as ratio droop, creep, creep rate, slip, or slip rate. The error for a given torque is known, for example by testing or other characterization, and can be stored in the calibration table 146. In some embodiments, the error relationship to torque magnitude is dependent upon the dynamic transition from mode 1 to mode 2 and vice versa. The torque reversal command module 136 is provided with a calibration table 148 to store an additive error value corresponding to the dynamic condition of a shift from mode 1 to mode 2. In some embodiments, the calibration table 148 can be an adaptive table that can learn during operation based on feedback from the system. The torque reversal command module 136 is provided with a calibration table 150 to store an additive error value corresponding to the dynamic condition of a shift from mode 2 to mode 1. In some embodiments, the calibration table 148 is configured with an additive error that is very large so as to produce an aggressive change in actuator position on the variator 2. Once the software has determined that a torque reversal is taking place, and which type of shift is occurring, a selector block 152 selects which table to use. The tables contain values which modify the ratio setpoint. For example: Negative values refer to a shift from mode 1 to mode 2 and positive values refer to a shift from mode 2 to mode 1. The duration of the modifier is capable of being calibrated. The magnitude of the modifier is determined by calibrating in such a way that the common moves the actuator enough to eliminate the droop, or at the very least (under very high torque conditions) reduce the slope of the ratio change. The torque reversal command module 136 is provided with the selector block 152 configured to pass the speed ratio setpoint based on the determination of a torque reversal event from mode 1 to mode 2, a torque reversal event from mode 2 to mode 1, or no torque reversal event.

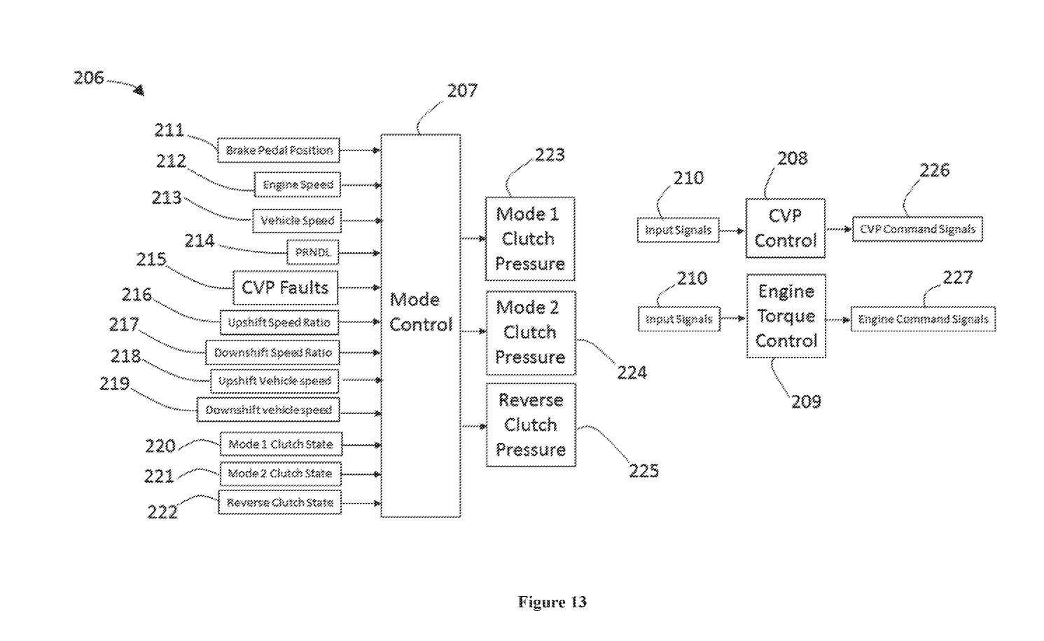

Referring now to FIG. 13, in some embodiments; a transmission control module 206 is implemented in the control system 100 in a similar capacity as the transmission control module 106. In some embodiments, the transmission control module 206 includes, but is not limited to, a mode control module 207, a variator control module 208, and an engine torque control module 209. The transmission control module 206 receives a number of input signals 210. In some embodiments, the input signals 210 include, but are not limited to, a brake pedal position signal 211, an engine speed signal 212, a vehicle speed signal 213, and a PRNDL position signal 214. The input signals 210 are provided by sensors equipped on the transmission 10, the engine, or the vehicle (not shown). In some embodiments, the mode control module 207 receives signals from a variator faults module 215. The variator faults module 215 is configured to monitor the overall performance of the variator and report perturbations in performance to the mode control module 207. The mode control module 207 receives a number of calibratable variables such as an upshift speed ratio variable 216, a downshift speed ratio variable 217, an upshift vehicle speed variable 218, and a downshift vehicle speed variable 219. In some embodiments, the calibratable upshift and downshift variables are optionally configured as calibratable maps or tables to allow the shift points to change based on operating conditions of the vehicle. The mode control module 207 receives a mode 1 clutch state signal 220, a mode 2 clutch state signal 221, and a reverse clutch state signal 222. The mode control module 207 implements a number of control processes and algorithms based on the input signals and delivers signals to a mode 1 clutch pressure module 223, a mode 2 clutch pressure module 224, and a reverse clutch pressure module 225. The mode 1 clutch pressure module 223, the mode 2 clutch pressure module 224, and the reverse clutch pressure module 225 executes a number of control processes and algorithms to form command signals for controlling the first clutch 14 and the second clutch 15, for example. In some embodiments, the variator control module 208 receives the input signals 210 and determines a number of variator command signals 226. The engine torque control module 209 receives the input signals 210 and determines a number of engine command signals 227.

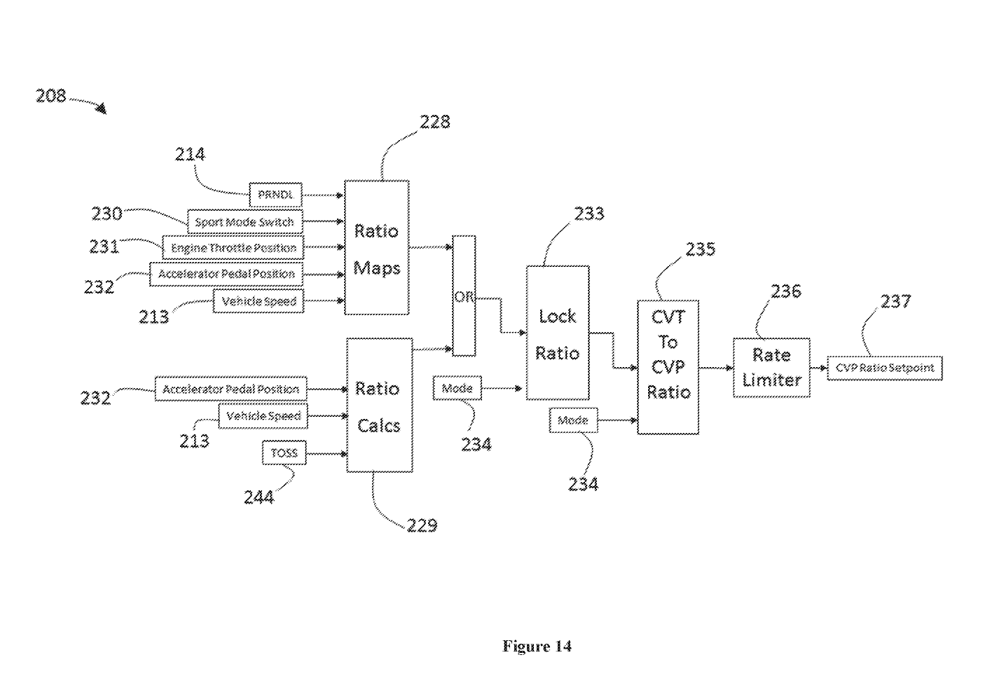

Turning now to FIG. 14, in some embodiments; the variator control module 208 includes a ratio map module 228 and a ratio calculation module 229. The ratio map module 228 receives the PRNDL position signal 214 and the vehicle speed signal 213, among other input signals such as a sport mode switch signal 230, an engine throttle position signal 231, and an accelerator pedal position signal 232. The sport mode switch signal 230 is a signal from the user-selectable switch and is indicative of a “sport mode” or in some cases an “economy mode”. The ratio calculation module 229 receives the accelerator pedal position signal 232, the vehicle speed signal 213, and a transmission output speed signal (“TOSS”) signal 244. In some embodiments, the variator control module 208 selects between the output of the ratio map module 228 and the output of the ratio calculation module 229 to pass to a lock ratio module 233. The lock ratio module 233 receives a mode signal 234 and the signal from either the ratio map module 228 or the ratio calculation module 229. The lock ratio module 233 implements a temporary hold or freeze to the speed ratio of the CVT based on the mode signal 234. For example, the speed ratio of the variator 12 is held at a constant value during a shift from mode 1 operation to mode 2 operation, or vice versa. The lock ratio module 233 passes a signal to a CVT-to-CVP ratio module 235. The CVT-to-CVP ratio module 235 is configured to convert an overall transmission (CVT) speed ratio setpoint to a variator (CVP) speed ratio setpoint based at least in part on the mode signal 234. The CVT-to-CVP ratio module 235 passes a signal to a ratio limiter module 236 and provides a variator ratio setpoint signal 237. It should be appreciated that the variator ratio setpoint signal 237 is one of the signals included in the variator command signals 226. In some embodiments, the variator control module 208 is configured to provide other command signals indicative of actuator commands or others.

Referring now to FIG. 15, in some embodiments; the ratio map module 228 includes a performance calibration map 238, an economy calibration map 239, and a third calibration map 240. In some embodiments, the performance calibration map 238 is a calibratable look-up table of CVT speed ratio setpoints based at least in part on the engine throttle position 231 and the vehicle speed 213. The performance calibration map 238 is typically programmed to provide faster acceleration for the vehicle. The economy calibration map 239 is a calibratable table or map of variator speed ratio setpoints based at least in part on the engine throttle position 231 and the vehicle speed 213. The economy calibration map 239 is typically programmed to provide optimal fuel efficiency during vehicle operation. In some embodiments, the third calibration map 240 is provided to implement other modes of operation such as a simulated stepped gear operating condition. The ratio map module 228 implements a selector 241 that passes a CVT ratio setpoint signal 242 based on the PRNDL position signal 214, the sport mode switch signal 230, and the accelerator pedal position signal 232.

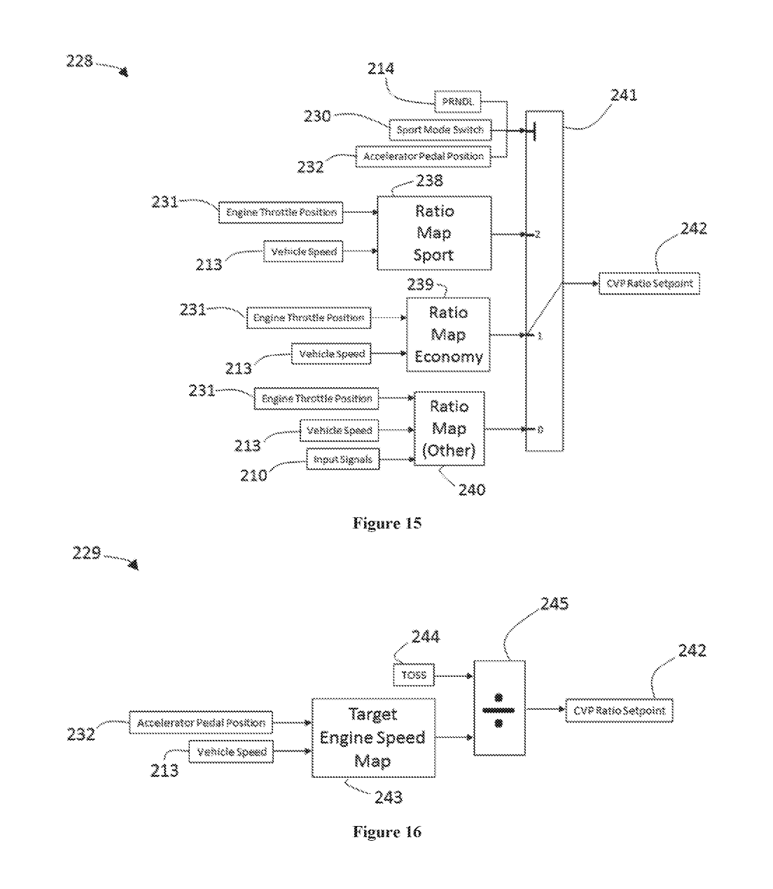

Referring now to FIG. 16, in some embodiments; the ratio calculation module 229 is configured to calculate the CVT speed ratio setpoint signal 242 based at least in part on the accelerator pedal position signal 232, the vehicle speed signal 213, and the transmission output speed signal 244. The ratio calculation module 229 includes a target engine speed map 243. The target engine speed map 243 is a calibratable map for values of engine speed based at least in part on the accelerator pedal position 232 and the vehicle speed 213. An algorithm block 245 receives the output signal from the target engine speed map 243 and the transmission output speed signal 244. The algorithm block 245 is programmed to calculate the CVT ratio setpoint 242. In some embodiments, the algorithm block 245 is programmed to implement the following function: the transmission output speed signal 244 divided by engine speed setpoint signal, where the engine speed setpoint signal is determined in the target engine speed map 243.

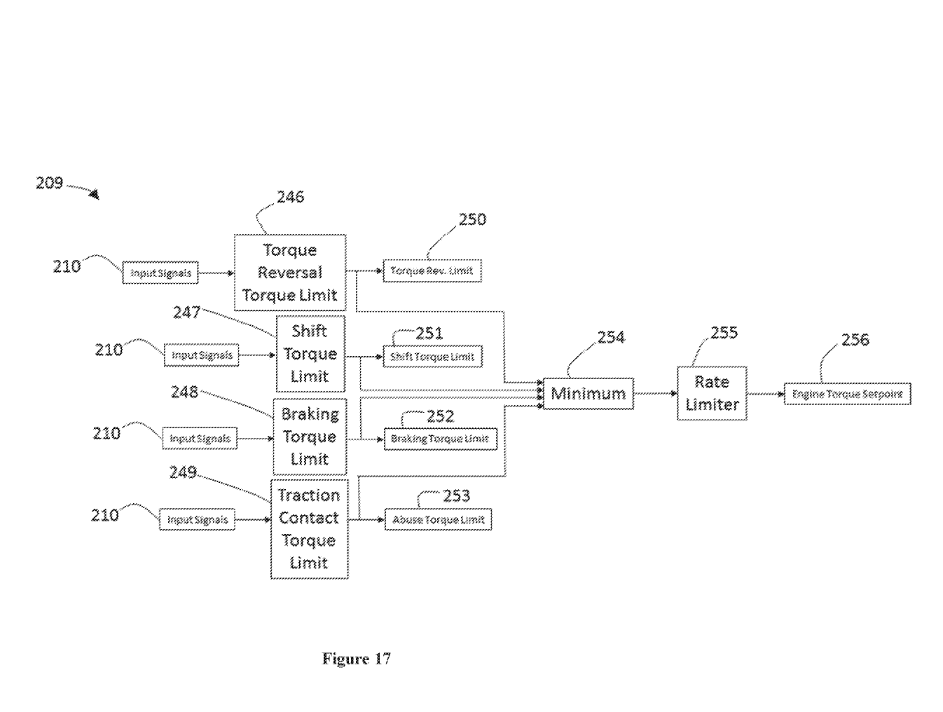

Turning now to FIG. 17, in some embodiments; the engine torque control module 209 includes a torque reversal torque limit sub-module 246, a shift torque limit sub-module 247, a braking torque limit sub-module 248, and a traction contact torque limit sub-module 249, each configured to receive the input signals 210. The torque reversal torque limit sub-module 246 is configured to implement a number of control processes in coordination with a number of calibratable maps to determine a torque reversal torque limit signal 250. The torque reversal torque limit signal 250 is indicative of a maximum engine torque allowable in the event of a reverse torque on the variator 12, for example. The shift torque limit sub-module 247 is configured to implement a number of control processes in coordination with a number of calibratable maps to determine a shift torque limit signal 251. The shift torque limit signal 251 is indicative of the maximum engine torque allowable in the event of a mode shift in the transmission. The braking torque limit sub-module 248 is configured to implement a number of control processes in coordination with a number of calibratable maps to determine a braking torque limit signal 252. The braking torque limit signal 252 is indicative of a maximum allowable engine torque during a braking event. The traction contact torque limit sub-module 249 is configured to implement a number of control processes in coordination with a number of calibratable maps to determine a traction contact torque limit signal 253. The traction contact torque limit signal 253 is indicative of a maximum engine torque allowed to be transmitted to the variator 12 due to thermal overload or other conditions related to the traction contact. The engine torque control module 290 includes a comparison module 254 that determines the minimum value among the torque reversal torque limit signal 250, the shift torque limit signal 251, the braking torque limit signal 252, and the abuse torque limit signal 253. The output signal from the comparison module 254 is passed to a rate limiter module 255 to form an engine torque setpoint signal 256. It should be appreciated that the engine torque setpoint signal 256 is included in the engine setpoint signals 227 among others.

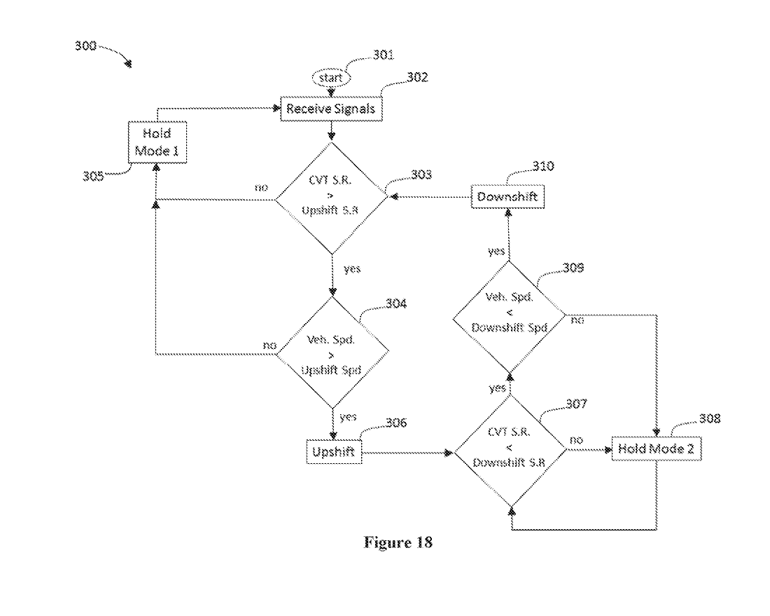

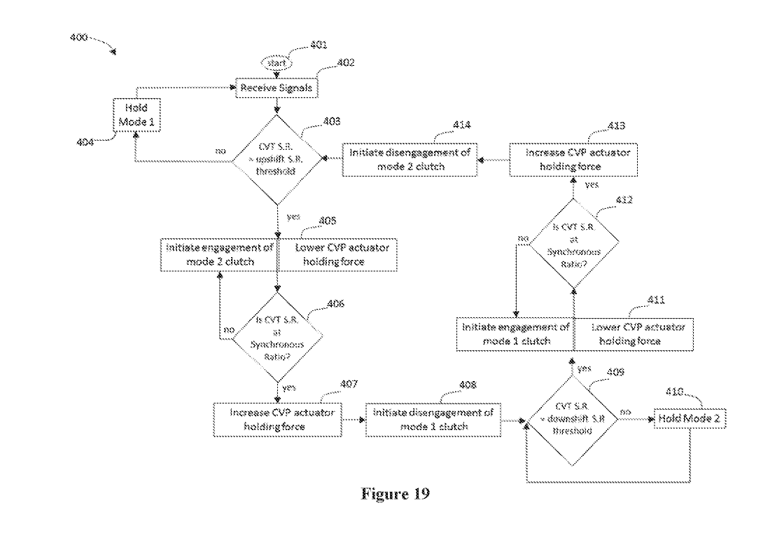

Passing now to FIG. 18, in some embodiments; the transmission control module 206 is configured to implement a control process 300. In some embodiments, the control process 300 is implemented in the mode control module 207. The control process 300 begins at a start state 301 and proceeds to a block 302 where a number of signals are received. In some embodiments, the block 302 receives signals indicative of a current CVT speed ratio and a current vehicle speed. The control process 300 proceeds to a first evaluation block 303 wherein the current CVT speed ratio is compared to an upshift speed ratio setpoint, for example the upshift speed ratio variable 216. If the current CVT speed ratio is less than the upshift speed ratio setpoint, the first evaluation block 303 delivers a false result and the control process 300 proceeds to a block 305 where instructions to hold the CVT in mode 1 are executed. If the current CVT speed ratio is greater than the upshift speed ratio setpoint, the first evaluation block 303 delivers a true result and the control process 300 proceeds to a second evaluation block 304. The second evaluation block 304 compares the current vehicle speed to an upshift vehicle speed setpoint, for example the upshift vehicle speed variable 218. If the current vehicle speed is less than the upshift vehicle speed setpoint, the second evaluation block 304 delivers a false result and the control process 300 proceeds to the block 305. If the current vehicle speed is greater than the upshift vehicle speed setpoint, the second evaluation block 304 delivers a true result and the control process 300 proceeds to a block 306 where instructions to upshift from mode 1 operation to mode 2 operation are executed. The control process proceeds to a third evaluation block 307 where the current CVT speed ratio is compared to a downshift speed ratio setpoint, for example the downshift speed ratio variable 217. If the current CVT speed ratio is greater than the downshift speed ratio setpoint, the third evaluation block 307 delivers a false result and the control process 300 proceeds to a block 308 where instructions to hold the transmission in mode 2 are executed. If the current CVT speed ratio is less than the downshift speed ratio setpoint, the third evaluation block 307 delivers a true result and the control process 300 proceeds to a fourth evaluation block 309. The fourth evaluation block 309 compares the current vehicle speed to a downshift vehicle speed setpoint, for example the downshift vehicle speed variable 219. If the current vehicle speed is greater than the downshift vehicle speed setpoint, the fourth evaluation block 309 delivers a false result and the control process 300 proceeds to 308. If the current vehicle speed is less than the downshift vehicle speed setpoint, the fourth evaluation block 309 delivers a true result and the control process 300 proceeds to a block 310. The block 310 executes instructions to downshift the transmission from mode 2 to mode 1 operation. The control process 300 returns to the first evaluation block 303.

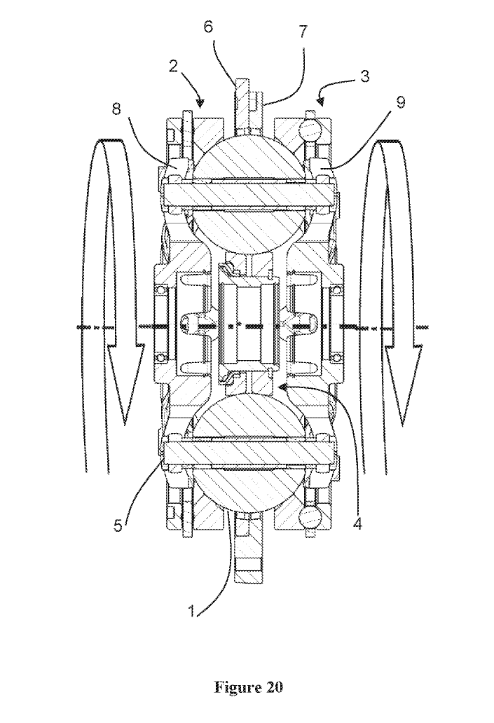

Passing now to FIG. 19, in some embodiments; the transmission control module 206 is configured to implement a control process 400. In some embodiments, the control process 400 is implemented in the mode control module 207. The control process 400 begins at a start state 401 and proceeds to a block 402 where a number of signals are received. In some embodiments, the block 402 receives signals indicative of a current CVT speed ratio and a current vehicle speed, among other signals associated with controlling the variator 12, the first clutch 14, and the second clutch 15, for example. The control process 400 proceeds to a first evaluation block 403 wherein the current CVT speed ratio is compared to an upshift speed ratio threshold. In some embodiments, the upshift speed ratio threshold is a calibrateable variable having a value near the synchronous speed ratio setpoint. In some embodiments, the upshift speed ratio threshold is optionally configured as a look-up table having calibrateable values based on other signals. In some embodiments, the control process 400 is optionally provided with a vehicle speed evaluation block (not shown) where a comparison of the current vehicle speed to an upshift vehicle speed threshold is made. It should be appreciated that a designer is capable of configuring the first evaluation block 403 to be a vehicle speed evaluation block in place of, or in addition to the evaluation of the current CVT speed ratio. If the first evaluation block 403 returns a false result, the control process 400 process proceeds to a block 404 where a command is sent to hold the transmission in mode 1, for example, by continuing to engage the first clutch 14. If the first evaluation block 403 returns a true result, the control process 400 proceeds to a block 405 where two commands are sent substantially simultaneously. The block 405 sends a command to initiate engagement of mode 2 clutch, for example the second clutch 15. The block 405 sends a command to reduce the variator actuator holding force to near zero force. For example, the variator actuator holding force is the force applied to a shift actuator of the variator 12. The control process 400 proceeds to a second evaluation block 406 where the current CVT speed ratio is compared to the synchronous speed ratio to determine if the CVT has reached the synchronous speed ratio. In some embodiments, the evaluation block 406 compares the current CVT speed ratio signal to a stored calibration variable indicative of the designed synchronous speed ratio. In other embodiments, the evaluation block 406 evaluates slip of the first clutch 14 and the second clutch 15 to determine if the clutches are in a locked condition. If both the first clutch and the second clutch are locked, for example the speed differential across the clutch elements is low or near zero, the CVT is at the synchronous shift point. It should be appreciated that the evaluation block 406 is optionally configured to implement a number of comparisons to determine if the CVT has reached the designed synchronous speed ratio. If the second evaluation block 406 returns a false result, the control process proceeds to the block 405. If the second evaluation block 406 returns a true result, the control process proceeds to a block 407 where a command is sent to increase, or reapply, the variator actuator holding force. The control process 400 proceeds to a block 408 where a command is send to initiate the disengagement of the mode 1 clutch, for example the first clutch 14. The control process 400 proceeds to a third evaluation block 409 where a current CVT speed ratio is compared to a downshift speed ratio threshold. In some embodiments, the third evaluation block 409 optionally includes a comparison of the current vehicle speed to a downshift vehicle speed threshold. If the result of the third evaluation block 409 is false, the control process 400 continues to a block 410 where a command is sent to hold the transmission in mode 2, for example by continuing to engage the second clutch 15. If the result of the third evaluation block 409 is true, the control process 400 proceeds to a block 411 where two commands are send substantially simultaneously. The block 411 sends a command to initiate the engagement of the mode 1 clutch, for example the first clutch 14. The block 411 sends a command to reduce the variator actuator holding force to near zero force. The control process 400 proceeds to a fourth evaluation block 412 where the current CVT speed ratio is compared to the synchronous speed ratio. If the fourth evaluation block 412 returns a false result, the control process proceeds back to the block 411. If the fourth evaluation block 412 returns a true result, the control process proceeds to a block 413 where a command is sent to increase or reapply the variator actuator holding force. The control process 400 proceeds to a block 414 where a command is sent to initiate disengagement of the mode 2 clutch, for example the second clutch 15. The control process 400 proceeds back to the first evaluation block 403.

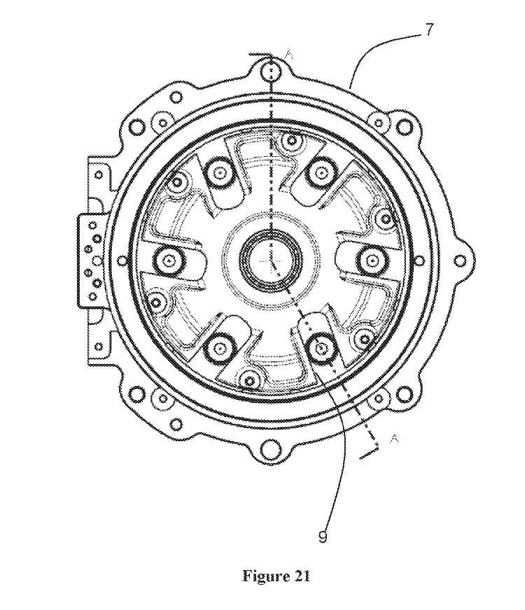

Provided herein are configurations of CVTs based on a ball type variators, sometimes referred to herein as a continuously variable planetary (“CVP”). Basic concepts of a ball type Continuously Variable Transmission are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface in contact with the balls, an input traction ring 2, an output traction ring 3, and an idler (sun) assembly 4 as shown on FIG. 20. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 21. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

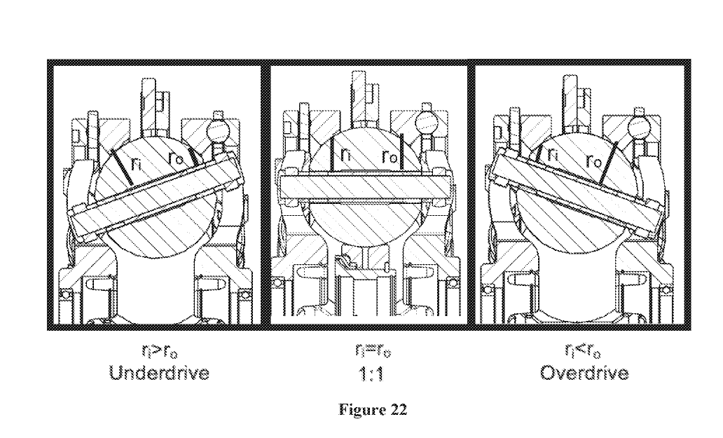

The working principle of such a CVP of FIG. 19 is shown on FIG. 22. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 22, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor can read information from, and write information to, the storage medium. In the alternative, the storage medium may be integral to the processor. The processor and the storage medium may reside in an ASIC. For example, in some embodiments, a controller for use of control of the IVT comprises a processor (not shown).

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-46. (canceled)

47. A method of operating a continuously variable transmission having a variator operably coupled to a multiple-mode gearing having a first clutch and a second clutch, the method comprising:
operating a continuously variable planetary having a plurality of tiltable balls in contact with a first traction ring assembly and a second traction ring assembly, wherein a speed ratio between the first traction ring assembly and the second traction ring assembly corresponds to a tilt angle of the balls;
operably coupling the continuously variable planetary to the first clutch and the second clutch;
comparing a current speed ratio of the transmission to an upshift speed ratio setpoint;
comparing a current vehicle speed to an upshift vehicle speed setpoint; and
commanding an upshift of the multiple mode gearing based at least in part on the comparisons.

48. The method of claim 47, further comprising comparing the current speed ratio of the transmission to a downshift speed ratio setpoint.

49. The method of claim 48, further comprising comparing the current vehicle speed to a downshift vehicle setpoint.

50. The method of claim 49, further comprising commanding a downshift of the multiple mode gearing based at least in part on the comparisons.

51. The method of claim 50, wherein commanding a downshift of the multiple mode gearing further comprises engaging the first clutch and disengaging the second clutch.

52. The method of claim 48, wherein commanding an upshift of the multiple mode gearing further comprises disengaging the first clutch and engaging the second clutch.

53. A method of operating a continuously variable transmission having a variator operably coupled to a multiple-mode gearing having a first clutch and a second clutch, the method comprising:
operating a continuously variable planetary having a plurality of tiltable balls in contact with a first traction ring assembly and a second traction ring assembly, wherein a speed ratio between the first traction ring assembly and the second traction ring assembly corresponds to a tilt angle of the balls;
operably coupling the continuously variable planetary to the first clutch and the second clutch;
operably coupling an actuator to the continuously variable planetary, the actuator configured to adjust the tilt angle of the balls, and the actuator configured to apply a holding force on the continuously variable planetary;
comparing a current speed ratio of the transmission to an upshift speed ratio threshold;
commanding a reduction in the holding force; and
commanding an upshift of the multiple mode gearing based at least in part on the comparison to the upshift speed ratio threshold.

54. The method of claim 53, further comprising comparing the current speed ratio of the transmission to a synchronous speed ratio setpoint.

55. The method of claim 54, further comprising commanding the disengagement of the first clutch based at least in part on the comparison of the current speed ratio of the transmission to the synchronous speed ratio setpoint.

56. The method of claim 55, further comprising commanding an increase in the holding force based at least in part on commanding the disengagement of the first clutch.

57. The method of claim 56, further comprising comparing the current speed ratio of the transmission to a downshift speed ratio threshold.

58. The method of claim 57, further comprising commanding a reduction of the holding force based at least in part on the comparison to the downshift speed ratio threshold.

59. The method of claim 58, further comprising commanding an engagement of the first clutch based at least in part on the comparison to the downshift speed ratio threshold.

60. The method of claim 53, further comprising comparing the current vehicle speed to an upshift vehicle speed threshold.

61. The method of claim 60, further comprising comparing the current vehicle speed to a downshift vehicle speed threshold.
